(19) United States
(12) Patent Application Publication
(10) Pub. No.: US 2015/0241753 A1
(43) Pub. Date: Aug. 27, 2015

(54) DISPLAY PANEL AND DISPLAY DEVICE

(71) Applicant: Sharp Kabushiki Kaisha, Osaka (JP)

(72) Inventors: Eiji Satoh, Osaka (JP); Tomoko Teranishi, Osaka (JP); Takuma Tomotoshi, Osaka (JP); Takahiro Nakahara, Osaka (JP)

(73) Assignee: Sharp Kabushiki Kaisha, Osaka (JP)

(21) Appl. No.: 14/422,323

(22) PCT Filed: Jul. 26, 2013
(86) PCT No.: PCT/JP2013/070294

§ 371 Date: Feb. 18, 2015

(30) Foreign Application Priority Data
Aug. 21, 2012 (JP) 2012-182685

(51) Int. Cl. G02F 1/167; G02F 1/1339

(52) U.S. Cl. CPC G02F 1/167; G02F 1/13394

(57) ABSTRACT

Provided are a display panel and a display device in which light usage efficiency can be improved using a simple structure. A light modulating layer disposed between substrates of a display panel includes a polar solvent, a non-polar solvent, and hydrophilic shape-anisotropic members. The hydrophilic substrate is in contact with the polar solvent and the hydrophobic substrate is in contact with the non-polar solvent. The disposition of the shape-anisotropic hydrophilic members in the light modulating layer is varied by varying the voltage applied to the light modulating layer.

### TECHNICAL FIELD

The present invention is directed to a display panel and a display device.

BACKGROUND ART

Conventional liquid crystal display panels mainly have a pair of glass substrates, a liquid crystal layer between these substrates, electrodes on each of these glass substrates, and a polarizing plate attached to each glass substrate. These types of liquid crystal display panels perform image display by using a reflective member to reflect light (external light) that enters the liquid crystal display panel and passes through the polarizing plate and the liquid crystal layer. However, much of the incident light is lost before reaching the display screen due to absorption and reflection, which is a factor that reduces light use efficiency. In particular, light loss caused by polarizing plates has a large effect on reducing light use efficiency.

Patent Document 1 describes an electrophoretic display having a plurality of rear electrodes, a suspending fluid, and a transparent electrode that forms the display surface, in which the suspending fluid has a plurality of particles that at least include one particle that is reflective. In addition, if an electric field is applied to the medium, the particles move through the electric field.

FIGS. 8(a) and 8(b) are cross-sectional views showing a schematic configuration of a conventional electrophoretic display. In the technology described in Patent Document 1, the suspending fluid is colored such that particles 108 are invisible to the viewers when the particles 108 are positioned as shown in FIG. 8(a), or in other words, in a position that is far from the viewer (towards substrate 114). As a result, the suspending fluid absorbs light. On the other hand, by applying a voltage having the opposite polarity to FIG. 8(a), the particles 108 move towards the viewer (transparent electrode 110 side) and perform light reflection or the like. According to this configuration, the reflective characteristics of the particles 108 have directionality.

### RELATED ART DOCUMENT

### Patent Document

Patent Document 1: US Pat. No. 7,312,916 (Dec. 25, 2007)

### SUMMARY OF THE INVENTION

### Problems to be Solved by the Invention

However, the technology in Patent Document 1 changes the intensity of the reflected light by moving particles within a medium that is colored such that the particles cannot be seen. In order to display white (reflective state), the colored medium between the reflective particles and the viewer side surface (display surface) needs to be removed completely in order to avoid being affected by the colored medium. However, the application of this type of process is very difficult. Thus, there is a problem that the viewer cannot obtain sufficient brightness.

The present invention was made in view of the above-mentioned problems and aims at providing a display panel and a display device that can improve light use efficiency with a simple structure.

### Means for Solving the Problems

In order to solve the problems mentioned above, the display panel related to the present invention includes a first substrate on a rear surface side; a second substrate on a display surface side facing the first substrate; and a light modulation layer that is disposed between the first substrate and the second substrate and that controls a degree of reflection of light incident thereon, wherein the light modulation layer includes a polar solvent, a non-polar solvent, and a plurality of shape-anisotropic members having one of hydrophilic, hydrophobic, and amphipathic characteristics, wherein one of the first substrate and the second substrate has the hydrophilic characteristics and is in contact with the polar solvent, wherein another one of the first substrate and the second substrate has the hydrophobic characteristics and is in contact with the non-polar solvent, wherein one of the polar solvent and the non-polar solvent that is in contact with the first substrate has light absorbing characteristics, and wherein a position of the shape-anisotropic members in the light modulation layer is changed by changing a voltage applied to the light modulation layer.

According to the configuration mentioned above, if a voltage is not applied to the light modulation layer and if the shape-anisotropic members are hydrophilic, then the shape-anisotropic members can be oriented (horizontally oriented) in the polar solvent, and if the shape-anisotropic members are hydrophobic, then the shape-anisotropic members can be oriented (horizontally oriented) in the non-polar solvent. Furthermore, if a voltage is applied to the light modulation layer, and if the shape-anisotropic members are hydrophilic or hydrophobic, then the position of shape-anisotropic members in the light modulation layer can be changed. The shape-anisotropic members can be contained within the solvent that is in contact with the first substrate, or be oriented (vertically oriented) such that the long axes thereof are in a direction perpendicular to the first and second substrates.

In this manner, the shape-anisotropic members can be contained in the polar solvent or the non-polar solvent when a voltage is not applied by making the shape-anisotropic members disposed between a hydrophilic substrate and a hydrophobic substrate either hydrophilic or hydrophobic. Therefore, the display panel can be used suitably without being affected by the light incident to the first substrate. Furthermore, the incident light can be absorbed by the solvent that is in contact with the first substrate by changing the position of the shape-anisotropic members in the light modulation layer through applying voltage thereto.

In addition, if the shape-anisotropic members are amphipathic, then applying voltage to the light modulation layer orients the shape-anisotropic members in the polar solvent or in the non-polar solvent. If a voltage having opposite polarity is applied to the light modulation layer, then the shape-anisotropic members that were oriented in the polar solvent orient in the non-polar solvent, and the shape-anisotropic members that were oriented in the non-polar solvent become oriented in the polar solvent.

By changing the characteristics of the shape anisotropic members between the hydrophilic substrate and the hydrophobic substrate to be amphipathic, the shape-anisotropic members can be contained in the solvent (polar solvent or non-polar solvent) that is in contact with the second substrate by applying a voltage to the light modulation layer, and the display panel can be used suitably without being affected by the solvent in contact with the first substrate on which the light is incident. Furthermore, the incident light can be absorbed by the solvent that is in contact with the first substrate because the shape-anisotropic members in the light modulation layer can change position when a voltage having opposite polarity is applied.

Therefore, it is possible to attain a display panel having a high rate of light use efficiency with a simple configuration.

It is preferable that the solvent in contact with the first substrate include a black pigment in the display panel mentioned above.

As a result, black display can be performed suitably.

Furthermore, the display panel can be structured such that when the shape-anisotropic members have hydrophilic characteristics, the shape-anisotropic members are confined within the polar solvent when respective long axes of the shape-anisotropic members are oriented parallel to the first substrate and the second substrate, wherein, when the shape-anisotropic members have the hydrophobic characteristics, the shape-anisotropic members are confined within the non-polar solvent when the respective long axes of the shape-anisotropic members are oriented parallel to the first substrate and the second substrate, and wherein, when the shape-anisotropic members have the amphipathic characteristics, the shape-anisotropic members are confined within one of the polar solvent and the non-polar solvent when the respective long axes of the shape-anisotropic members are oriented parallel to the first substrate and the second substrate.

As a result, the shape-anisotropic members can be stabilized in a position within the polar solvent or the non-polar solvent when being horizontally oriented.

In the display panel mentioned above, if the shape-anisotropic members are hydrophilic, then the layer thickness of the polar solvent is smaller than the layer thickness of the non-polar solvent, and if the shape-anisotropic member is hydrophobic, then the layer thickness of the non-polar solvent is smaller than the layer thickness of the polar solvent.

In the display panel mentioned above, the light modulation layer can be configured so as to absorb light when a voltage is applied thereto and to reflect light when no voltage is applied thereto.

In the display panel mentioned above, the shape-anisotropic members can be configured such that the area thereof projected onto the first and second substrates changes by changing the voltage applied to the light modulation layer.

It is preferable that the shape-anisotropic members have a charge.

As a result, the response speed of the shape-anisotropic members can be increased because interfacial tension and electrophoretic force can be used.

In the display panel mentioned above, it is preferable that the shape-anisotropic members have one of the hydrophilic characteristics and the hydrophobic characteristics, wherein, when the shape-anisotropic members have the hydrophilic characteristics, ribs are formed on one of the first substrate and the second substrate having the hydrophilic characteristics, and wherein, when the shape-anisotropic members have the hydrophobic characteristics, the ribs are formed on one of the first substrate and the second substrate having the hydrophobic characteristics.

The shape-anisotropic members of the display panel may have amphipathic characteristics, and the rib may be formed on either the first or second substrate.

As a result, deviation in flake density due to coagulation or the like caused by gravity and applying voltage thereto can be prevented.

It is preferable that the ribs in the display panel be formed in a matrix or in an island shape.

It is preferable that the height of the rib of the display panel be substantially the same as the thickness of the light modulation layer.

As a result, the ribs can be used as a spacer that maintains the distance between the first substrate and the second substrate.

In the display panel mentioned above, it is preferable that the height of the rib be 5 μm or less.

As a result, the width of the ribs can be set to be very narrow, and the area in which the flakes do not exist can be reduced.

In the display panel mentioned above, it is preferable that the shape-anisotropic members be made of a metal, a semiconductor, a dielectric material, a dielectric multilayer film, or a cholesteric resin.

In the display panel mentioned above, the shape-anisotropic members can be formed of metal and can be configured such that light radiated thereto is reflected.

As a result, reflective display can be performed.

In addition, the shape-anisotropic members may be colored in the display panel mentioned above.

In the display panel, it is preferable that the shape-anisotropic members be formed in a flake shape, a columnar shape, a sphere shape, an elliptical sphere shape, or the like, for example.

In the display panel, the shape-anisotropic members can be formed in a flake shape that has a surface having recesses and protrusions.

A display device that has the display panel mentioned above is also included in the scope of the present invention. As a result, a reflective display device can be realized.

### Effects of the Invention

The display panel of the present invention includes a display panel having a first substrate on a rear surface side; a second substrate on a display surface side facing the first substrate; and a light modulation layer that is disposed between the first substrate and the second substrate and that controls a degree of reflection of light incident thereon, wherein the light modulation layer includes a polar solvent, a non-polar solvent, and a plurality of shape-anisotropic members having one of hydrophilic, hydrophobic, and amphipathic characteristics, wherein one of the first substrate and the second substrate has the hydrophilic characteristics and is in contact with the polar solvent, wherein another one of the first substrate and the second substrate has the hydrophobic characteristics and is in contact with the non-polar solvent, wherein one of the polar solvent and the non-polar solvent that is in contact with the first substrate has light absorbing characteristics, and wherein a position of the shape-anisotropic members in the light modulation layer is changed by changing a voltage applied to the light modulation layer.

Therefore, it is possible to attain a display panel having a high rate of light usage with a simple configuration.

### BRIEF DESCRIPTION OF THE DRAWINGS

FIGS. 1(a) and 1(b) are cross-sectional views of a schematic configuration of a display device according to Embodiment 1.

FIG. 2(a) shows a light progression state of FIG. 1(a), FIG. 2(b) shows a light progression state of FIG. 1(b), and FIG. 2(c) shows how the flakes move to the polar solvent due to interfacial tension between the flakes and the non-polar solvent.

FIG. 3 shows an example of a position of the flakes when a voltage having a strength that is insufficient to cause the flakes to enter the black solvent is applied to the display panel.

FIG. 4 shows an example of a position of the flakes when a voltage having an opposite polarity to the polarity that charges the flakes is applied to the electrode disposed towards the viewer.

FIG. 5(a) is a perspective view showing ribs in a grid pattern, and FIG. 5(b) is a perspective view showing ribs in an island shape.

FIGS. 6(a) and 6(b) are cross-sectional views of a schematic configuration of a display device according to Embodiment 2.

FIGS. 7(a) and 7(b) are a cross-sectional view of a schematic configuration of a display device according to Embodiment 3, and FIG. 7(c) shows a flake rotating due to interfacial tension between the flakes and the non-polar solvent.

FIGS. 8(a) and 8(b) are cross-sectional views showing a schematic configuration of a conventional electrophoretic display.

### DETAILED DESCRIPTION OF EMBODIMENTS

### Embodiment 1

A display device related to Embodiment 1 of the present invention will be explained using drawings.

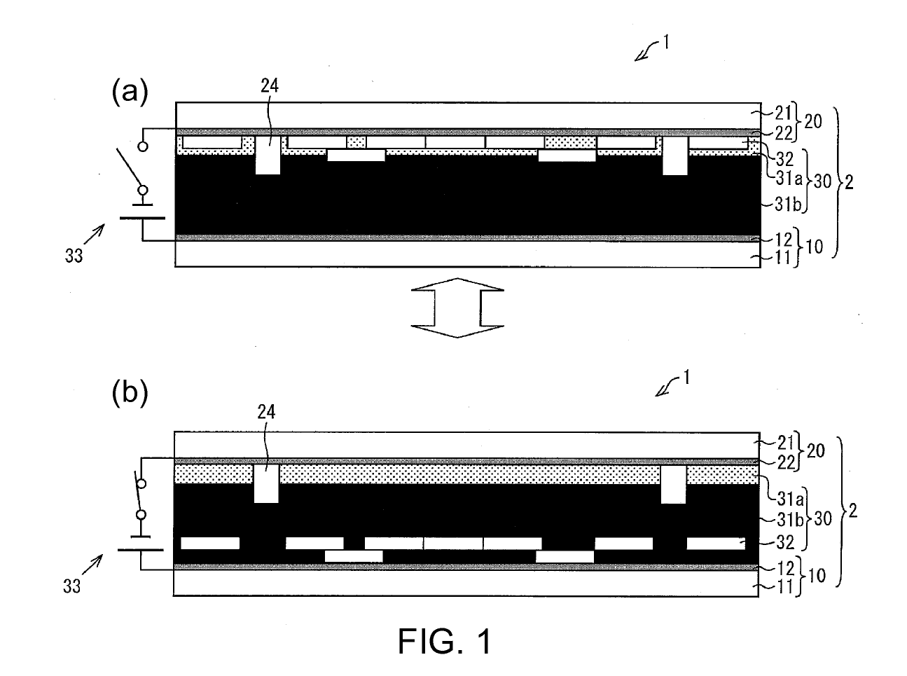

FIGS. 1(a) and 1(b) are cross-sectional views showing a schematic configuration of a display device 1 according to Embodiment 1. A display device 1 having a display panel 2 and a driving circuit (not shown) is a reflective display device that performs display by reflecting external light (incident light) that enters the display panel 2.

The display panel 2 includes a pair of substrates 10 and 20 arranged so as to face each other, and a light modulation layer 30 disposed between this pair of substrates 10 and 20. The substrate 10 (first substrate) is disposed on the rear side of the display panel 2 and the substrate 20 (second substrate) is disposed on the display surface side (viewer's side). In addition, the display panel 2 has a plurality of pixels arranged in a matrix.

(Substrate)

The substrates 10 and 20 respectively have insulating substrates 11 and 21 formed of transparent glass substrates, and electrodes 12 (first electrode) and 22 (second electrode), for example.

Hydrophobic treatment is performed on at least one side of the substrate 10 that comes into contact with the light modulation layer 30, and hydrophilic treatment is performed on at least one side of the substrate 20 that comes into contact with the light modulation layer 30. By performing hydrophobic treatment on the substrate 10, the substrate 10 comes into contact with the non-polar solvent that is sealed with the polar solvent in the light modulation layer 30. As a specific method of performing hydrophobic treatment, a method of spin coating fluorine resins such as Teflon®, AF (DuPont Co., Ltd.), and Cytop (Asahi Glass Co., Ltd.), and a method of forming a parylene film by CVD (chemical vapor deposition), for example, can be used.

By performing hydrophilic treatment on the substrate 20, the substrate 20 comes into contact with the polar solvent of the polar solvent and non-polar solvent sealed in the light modulation layer 30. Specific methods of hydrophilic treatment includes forming an inorganic oxide film of silicon oxide, titanium oxide, aluminum oxide, zinc oxide, or the like through vacuum deposition, sputtering, CVD, PVD (physical vapor deposition), sol-gel method, and coating method, or the like, or by performing surface treatment using a silane coupling agent having a polar group, for example.

It may be that hydrophobic treatment is performed on the substrate 20 and that hydrophilic treatment is performed on the substrate 10.

As mentioned above, the display device of the present invention has a structure in which one of a pair of substrates has hydrophilic characteristics and is in contact with a polar solvent and another of the pair of substrates has hydrophobic characteristics and is in contact with the non-polar solvent.

The inner side of the substrates 10 and 20 sandwiching the light modulation layer 30 may have a conductive electrode film of ITO, aluminum-vapor deposited layer, or the like formed on the entire surface, may have electrodes patterned such that segment display or passive display is possible, and may have an active matrix substrate such as a TFT (thin film transistor) formed on at least one substrate. Below, an example in which the substrate 10 is the active matrix substrate will be explained.

Specifically, the substrate 10 has, on the insulating substrate 11, various types of signal wiring lines (scan signal lines, data signal lines, and the like), thin-film transistors (“TFTs”), and an insulating film that are not shown. The electrodes 12 (pixel electrodes) are arranged on top of these. The configuration of the driving circuits that drive the various types of signal wiring lines (scan signal line driving circuit, data signal line driving circuit, and the like) is the same as a conventional configuration.

The substrate 20 has the electrode 22 (common electrode) disposed on an insulating substrate 21.

The electrode 12 formed on the substrate 10 and the electrode 22 formed on the substrate 20 are formed of transparent conductive films such as ITO (indium tin oxide), IZO (indium zinc oxide), zinc oxide, or tin oxide. The electrode 12 is formed for each pixel, and the electrode 22 is formed in a uniformly planar shape across all of the pixels. The electrode 22 may be formed for each pixel in a manner similar to the electrode 12.

Furthermore, among the electrodes 12 and 22, the electrode (electrode 22 in FIG. 1) formed on the substrate (substrate disposed on the display surface side of the display panel 2) to which external light is incident is formed of a transparent electrode. Furthermore, the electrode (electrode 12 in FIG. 1) formed on the substrate disposed on the rear side of the display panel 2 may be formed of a transparent electrode or an electrode that is not transparent.

(Light Modulation Layer)

The light modulation layer 30 is provided between the electrodes 12 and 22, and has a medium (polar solvent 31a and non-polar solvent 31b), and a plurality of anisotropic members 32 included in the medium. When a voltage is applied to the light modulation layer 30 by a power source 33 connected to the electrodes 12 and 22, the light modulation layer 30 changes the reflectance of incident light (external light) that is incident thereon in accordance with the size of the applied voltage.

(Shape-Anisotropic Member)

The shape-anisotropic members 32 are members that have a positive or negative charge in the medium. Specifically, the members that can be used include members that can exchange electrons with an electrode, a medium, or the like, members covered with polymer or the like including quaternary ammonium, members covered with polyethylene oxide or the like that can selectively capture ions, or members that have been modified with an ionic silane coupling agent having a polar group or the like.

The shape-anisotropic members 32 can adopt a flake shape, a columnar shape, a sphere shape, an elliptical sphere shape, or the like, for example. Furthermore, the shape-anisotropic members 32 may have characteristics that reflect visible light and may be made of a metal such as aluminum or silver, or may be a non-metal having a metal mentioned above coated by vapor deposition, for example. Alternatively, a dielectric multilayer film or a cholesteric resin can be used. The shape-anisotropic members 32 can be made of a metal, a semiconductor, a dielectric material, or a composite of these. In addition, the shape-anisotropic members 32 may be colored.

It is preferable that the specific weight of the shape-anisotropic members 32 be 11 g/cm³ or less, and it is even more preferable that the specific weight be similar to that of the medium (polar solvent 31 and non-polar solvent 31b). This is because if the specific weight of the shape-anisotropic members 32 differs greatly from that of the medium, there would be a problem that the shape-anisotropic members 32 sink or float in the medium.

Furthermore, the shape-anisotropic members 32 have hydrophilic or hydrophobic treatment applied to the surface thereof. A known method can be used for treating the surface. The sol-gel method of coating with silicon dioxide can be used as a method of hydrophilic treatment, and dip coating of fluorine resins can be used as a method of hydrophobic treatment. On the other hand, surface treatment may not be performed on the shape-anisotropic members 32, and the shape-anisotropic members 32 themselves may be formed of hydrophilic members or hydrophobic members. Aluminum oxide can be used as hydrophilic members, and PET (polyethylene terephthalate) can be used as hydrophobic members. As mentioned above, the shape-anisotropic members 32 have hydrophilic or hydrophobic characteristics. FIG. 1 shows a case in which the shape-anisotropic members 32 have hydrophilic characteristics.

If flakes are used for the shape-anisotropic members 32, it is preferable that the thickness thereof be less than or equal to 1 μm, and even more preferable that the thickness thereof be less than or equal to 0.1 μm. If the flakes are thin, then the probability of the light incident on a flake being multiply-reflected by another flake is low, and thus a display with high reflectance can be obtained.

Furthermore, if the shape of the shape-anisotropic members 32 is close to a sphere, then the resistance of the shape-anisotropic members 32 during electrophoresis can be reduced, and thus a faster response speed can be obtained.

In addition, if metal specks are used as flakes, then it is possible to scatter reflected light and to achieve a white display by forming the metal specks at an average diameter of 20 μm or below, forming the surfaces of the flakes so as to have recesses and protrusions that have light scattering characteristics, and forming the contours of the flakes to have acute recesses and protrusions (shape having recesses and protrusions).

(Medium)

The medium is formed of the polar solvent 31a that comes into contact with the substrate 20 that is hydrophilic and of the non-polar solvent 31b that comes into contact with the hydrophobic substrate 10. One of the polar solvent 31a and the non-polar solvent 31b that is disposed towards the viewer can be a substance having transparency in the visible light range, and a liquid that generally does not absorb light in the visible light range, a liquid colored by a dye, or the like. Furthermore, among the polar solvent 31a and the non-polar solvent 31b, the one that is disposed on the rear surface side of the display panel (solvent that is farther away from the viewer) can be a solvent having a substance (black pigment or the like, for example) dissolved therein that absorbs light with a wavelength that the flakes can reflect. If a black pigment will be dissolved in the polar solvent 31a, then a water-soluble pigment such as the BONJET® BLACKCW-1 (Orient Chemical Industries Co., Ltd.), and a water-soluble dye such as the WATERBLACK31 (Orient Chemical Industries Co., Ltd.) can be used. If a black pigment will be dissolved in the non-polar solvent 31b, then an oil-soluble dye such as Savinyl® BlackRLSN (Clariant) can be used.

It is preferable that the polar solvent 31a and the non-polar solvent 31b have specific weight that is equal to each other, or are similar to each other. Furthermore, it is preferable that the specific weights of the solvents be similar to that of the shape-anisotropic members 32. By making the polar solvent 31a and the non-polar solvent 31b have the same specific weight, regardless of the direction in which the display device 1 is held, the structure of the polar solvent 31a layer and the structure of the non-polar solvent 31b layer can be stably maintained.

It is preferable that the polar solvent 31a and the non-polar solvent 31b have low volatility when considering the process of sealing the solvents in the cell (light modulation layer 30). The viscosity of the polar solvent 31a and the non-polar solvent 31b relates to the responsiveness, and it is preferable that the viscosity be 5 mPa·s or less.

In addition, the polar solvent 31a and the non-polar solvent 31b may be formed of a single substance, or a mixture of a plurality of substances. Organic solvents such as water, alcohol, acetone, formamide, or ethylene glycol, or ionic liquid, or a mixture of these can be used as the polar solvent 31a, and silicone oil, aliphatic hydrocarbons, or the like can be used as the non-polar solvent 31b.

In FIG. 1, a case in which the polar solvent 31a is the solvent disposed on the viewer side, and the non-polar solvent 31b is the solvent disposed on the rear side of the display panel 2 is shown.

As mentioned above, the display panel 2 has the power source 33, the hydrophilic shape-anisotropic members 32, the polar solvent 31 that is in contact with the hydrophilic substrate, and a non-polar solvent 31b that is in contact with the hydrophobic substrate. Furthermore, the solvent that is farther away from the viewer has light absorbing characteristics, and includes black pigments, for example. According to this configuration, when a voltage is not applied to the light modulation layer 30, the shape-anisotropic members 32 are trapped in a certain narrow area within the polar substrate in a scattered state. If the shape-anisotropic members 32 are hydrophobic, the shape-anisotropic members 32 are trapped in a certain narrow area within the non-polar solvent 31b in a scattered state when a voltage is not applied to the light modulation layer 30.

It is preferable that the proportion (layer thickness) of the polar solvent 31a be different from the proportion (layer thickness) of the non-polar solvent 31b.

If the shape-anisotropic members 32 are hydrophilic (FIG. 1(a)), then the proportion (layer thickness) of the polar solvent 31a will be smaller than the proportion (layer thickness) of the non-polar solvent 31b. It is preferable that the layer thickness of the polar solvent 31a be 1 μm or less, and it preferable that the layer thickness be set to be the thickness of the shape-anisotropic members 32 or the thickness of several of the shape-anisotropic members 32. The shape-anisotropic members 32 are stably oriented in a position within the narrow polar solvent 31a. If flakes are used as the shape-anisotropic members 32, then the flakes are oriented (hereinafter, also referred to as horizontally oriented) so as to attach to the hydrophilic substrate (substrate 20 in FIG. 1). As a result, if a reflective member of visible light is used as the flakes, then the light (external light) that is incident on the light modulation layer 30 is reflected by the flakes, and thereby a reflected state of the incident light can be obtained.

If the shape-anisotropic members 32 are hydrophobic, then the proportion (layer thickness) of the non-polar solvent is made smaller than the proportion (layer thickness) of the polar solvent 31a. It is preferable that the layer thickness of the non-polar solvent 31b at this time be 1 μm or less, and it is preferable that the layer thickness of the shape-anisotropic members 32 be set as the thickness of the shape-anisotropic members 32 or the thickness of several of the shape-anisotropic members 32. The shape-anisotropic members 32 are stably oriented in a position within the narrow non-polar solvent 31b. If flakes are used as shape-anisotropic members 32, then the flakes are oriented (horizontally oriented) so as to attach to the hydrophobic substrate. As a result, if a reflective member of visible light such as metal is used as the flakes, then the light (external light) that is incident on the light modulation layer 30 is reflected by the flakes, and the reflective state of the incident light can be obtained.

(Control Method of Reflectance of Light by Light Modulation Layer)

Next, a method of controlling the reflectance of light using the light modulation layer 30 will be described in detail. A case in which hydrophilic flakes are used as the shape-anisotropic members 32 will be described below. The shape-anisotropic members 32 are negatively charged within the medium. Also, the non-polar solvent 31b is colored in black.

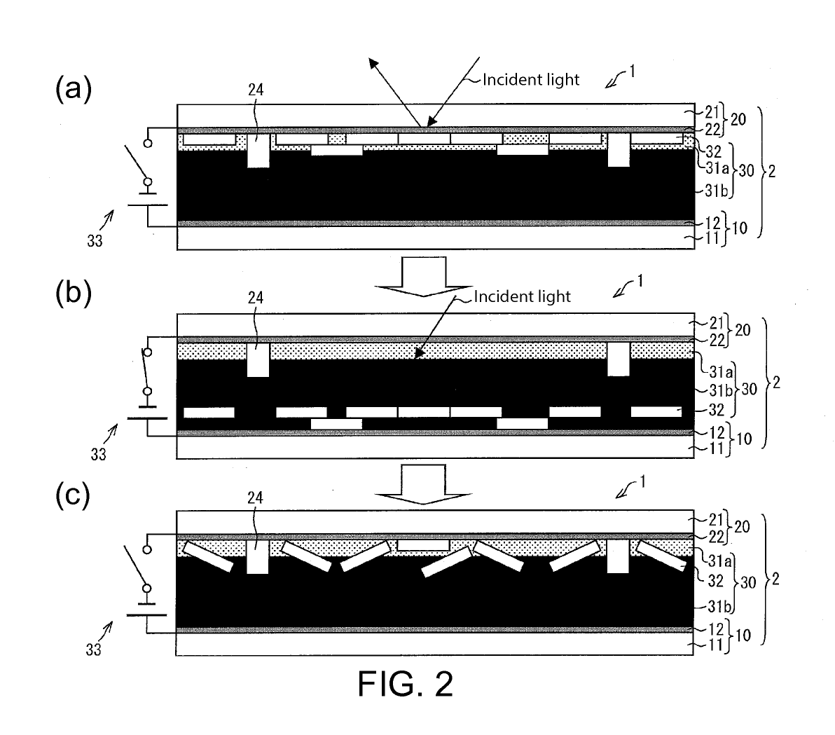

FIG. 2(a) shows a light progression state of FIG. 1(a), FIG. 2(b) shows a light progression state of FIG. 1(b), and FIG. 2(c) shows how the flakes move to the polar solvent 31a due to the interfacial tension that occurs between the flakes and the non-polar solvent 31b.

If a direct current voltage is not applied from the power source 33 to the light modulation layer 30, then, as shown in FIG. 2(a), the flakes are trapped in a certain narrow area within the polar solvent 31a in a scattered state. In other words, the flakes are stable in a position within the polar solvent 31a (inside polar solvent 31a), and are oriented so as to attach to the hydrophilic substrate 20. As a result, the light (external light) that is incident on the light modulation layer 30 is reflected by the flakes, and reflective display (white display) is performed.

As shown in FIG. 2(b), if a direct current voltage is applied to the light modulation layer 30 from the power source 33, then, the flakes enter the non-polar solvent 31b that is colored in black (also referred to as black medium) due to electrophoretic force. As a result, the light that is incident on the light modulation layer 30 is absorbed by the pigment of the non-polar solvent 31b. Thus, the viewer sees the black color of the non-polar solvent 31b (black display).

If the voltage applied to the light modulation layer 30 in FIG. 2(b) is not applied (voltage is 0), then, as shown in FIG. 2(c), due to the interfacial tension that occurs between the flakes and the non-polar solvent 31b, the flakes are oriented (horizontally oriented) so as to attach to the hydrophilic substrate 20, and is trapped (state shown in FIG. 2(a)) in a layer that is not colored black (polar solvent 31a). As a result, the external light that is incident on the light modulation layer 30 is reflected by the flakes, and reflective display (white display) is performed.

Whether the flakes are oriented in (1) a horizontal orientation so as to attach to the substrate (substrate 10 in FIG. 2) that is in contact with the black medium, (2) a horizontal orientation in front of the black medium (on a surface in contact with the non-polar solvent 31b in the polar solvent 31a in FIG. 2), (3) an orientation somewhere between (1) and (2), or the like depends on the balance between (i) the strength of the electrophoretic force related to the strength of the electric field that is based on the electrostatic charge of the flakes and the voltage applied thereto, and (ii) the interfacial tension that occurs when the flakes (hydrophilic flakes in FIG. 2) enter the black medium (non-polar solvent 31b).

If the layer thickness of the polar solvent 31a is sufficiently larger than the thickness of the flakes, then the position of the flakes cannot be completely controlled during the time between no voltage being applied and flakes starting to enter the non-polar solvent 31b. Meanwhile, the position of the flakes can be controlled by having the layer thickness of the polar solvent 31a be made (i) similar to or smaller (thinner) than the thickness of the flakes, or (ii) similar to or smaller (thinner) than the thickness of several flakes if more flakes than the amount needed to cover the display surface (substrate surface) are inserted. As a result, the space in which the flakes can move is reduced or is eliminated, and the position of the flakes can be controlled.

The advantages of making the layer thickness of the polar solvent 31a larger (thicker) than the thickness of the flakes will be explained below.

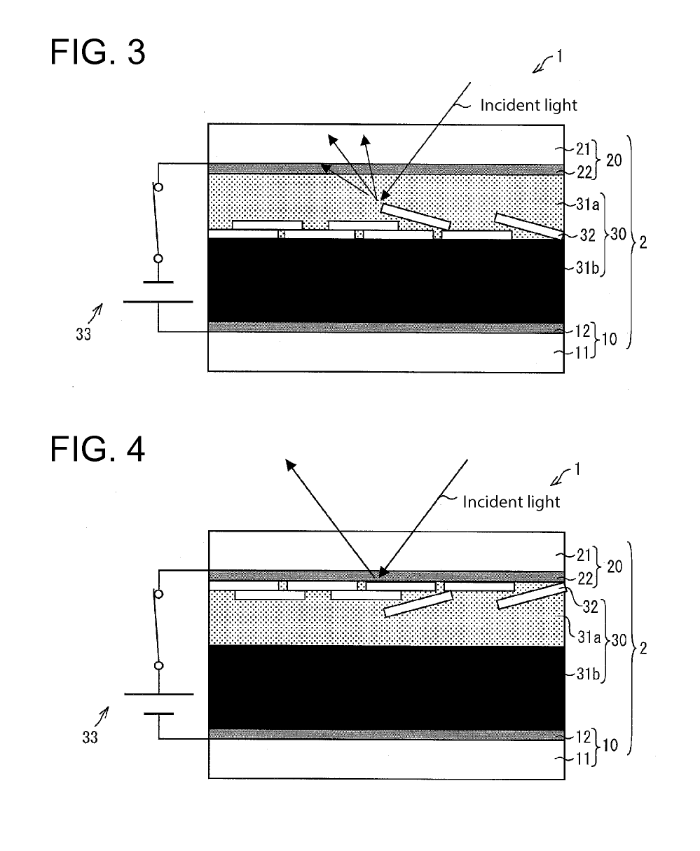

FIG. 3 shows an example of a position of the flakes when a voltage applied to the display panel 2 is insufficient to make the flakes enter the black medium. Furthermore, FIG. 4 shows an example of a position of the flakes in which a voltage having an opposite polarity to the polarity that charges the flakes is applied to the electrode.

As shown in FIG. 3, if a voltage that is not enough to make the flakes enter the black medium is applied to the display panel 2, then the flakes in the polar solvent 31a gathers and piles up on a surface (interface) of the polar solvent 31a that is in contact with the non-polar solvent 31b. As a result, if the layer thickness of the polar solvent 31a is made sufficiently larger (thicker) than the thickness of the flakes, then the display panel 2 can obtain scattered light because the incident light is reflected by the rough surface of the flakes.

Furthermore, the flakes attach to the substrate 20 in parallel thereto if a voltage with a polarity opposite to the polarity that charges the flakes is applied to the electrode that is on the viewer side. As a result, if the layer thickness of the polar solvent 31a is made sufficiently larger (thicker) than the thickness of the flakes, the display panel 2 can obtain mirror reflection of the incident light.

In this manner, if the layer thickness of the polar solvent 31a is made sufficiently larger (thicker) than the thickness of the flakes, then the display panel 2 can control the reflected light.

Furthermore, the state (halftone) in which the flakes are oriented in the middle of the medium can be controlled by changing how deep the flakes enter the non-polar solvent 31b and by changing the size of the voltage applied to the light modulation layer or how long the voltage is being applied.

Furthermore, the amount of flakes that enters the lower layer (solvent farther away from the viewer) when a voltage is applied can be controlled by having variations among the flakes in the amount of electrostatic charge and level of hydrophilic characteristics.

The display panel 2 may control the halftone of the flakes by using the two methods mentioned above.

In addition, the strength to move the flakes to the upper layer (solvent in the viewer side) may be only interfacial tension, but the present invention is not limited to this. As shown in FIG. 4, the display panel 2 can move the flakes to the upper layer by using both the electrophoretic force and the interfacial tension by applying a voltage having an opposite polarity to that of the flakes to the electrode in the viewer side. As a result, a faster response speed can be obtained.

Furthermore, the display panel 2 shown in FIGS. 3 and 4 performs display by positively or negatively charging the electrode 12 or 22. As a result, if the pixel is driven by using TFTs using a semiconductor having low leakage in an OFF state, then an image written can be stored for a certain time. Thus, low power consumption display can be performed.

In this manner, the display panel 2 related to the present embodiment can change the position of the shape-anisotropic members 32 in the light modulation layer 30 by changing the size of the voltage and the time of applying the voltage to the light modulation layer 30.

According to the configuration mentioned above, the shape-anisotropic members 32 can be oriented (horizontally oriented) in the polar solvent 31a when a voltage is not applied to the light modulation layer 30 and the shape-anisotropic members 32 are hydrophilic. In addition, the shape-anisotropic members 32 can be oriented (horizontally oriented) in the non-polar solvent 31b of the shape-anisotropic members 32 if the shape-anisotropic members 32 are hydrophobic. Furthermore, if voltage is applied to the light modulation layer 30, then the shape-anisotropic members 32 can be contained in the solvent (non-polar solvent 31b in FIG. 1) in contact with the substrate 10.

In this manner, by making the shape-anisotropic members 32 disposed between the hydrophilic substrate and the hydrophobic substrate hydrophilic or hydrophobic, the shape-anisotropic members 32 can be contained in the polar solvent 31a or the non-polar solvent 31b. Therefore, the display panel 2 can suitably use the incident light without being affected by the solvent in contact with the first substrate. In addition, when a voltage is applied, the shape-anisotropic members 32 can be contained in a solvent colored in black, and the incident light can be absorbed by the solvent colored in black. Therefore, it is possible to attain a display panel having a high rate of light usage with a simple configuration.

(Rib)

Ribs 24 are formed on the substrate (substrate 20 in FIG. 1) that the flakes attach to in the display panel 2. As a result, deviation in flake density due to coagulation or the like caused by gravity and applying voltage can be prevented.

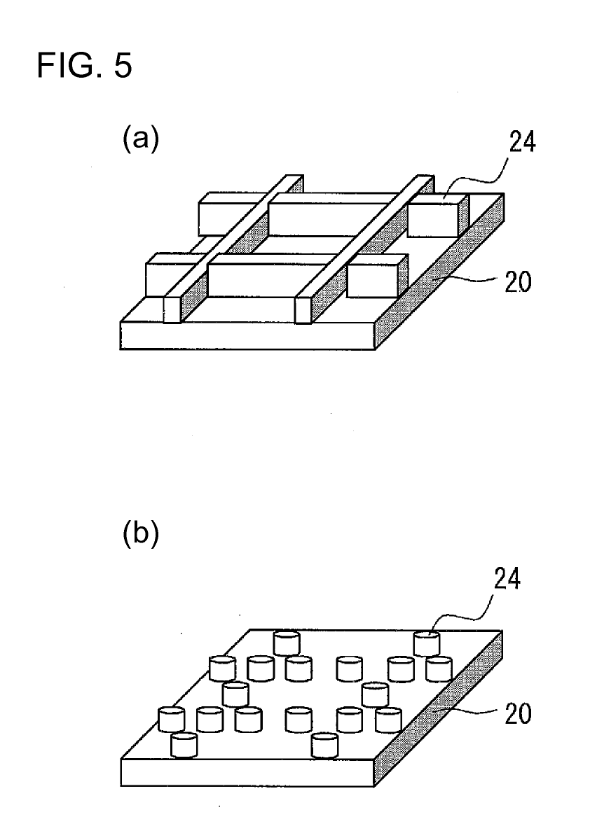

FIG. 5(a) shows a perspective view of ribs in a grid shape, and FIG. 5(b) shows a perspective view of ribs in an island shape.

The shape of the ribs 24 can take any form as long as it can prevent the flakes from deviating towards the inner surface direction, and may take a grid shape as in FIG. 5(a), or may take an island shape as shown in FIG. 5(b). FIG. 1 show ribs 24 (FIG. 5(a)) in a grid shape. The size of the area divided by the ribs 24 may be a size that corresponds to the area of each pixel, may be a size that divides each pixel into a plurality of areas, or a size that corresponds to an area of a group of pixels.

The height of the ribs 24 needs to be greater than or equal to the layer thickness of the polar solvent 31a or the non-polar solvent 31b in which the flakes disperse. If the height of the ribs 24 is equivalent to the desired cell thickness, then the ribs 24 can function as a spacer that maintains the distance between the substrates 10 and 20. On the other hand, if the height is set to be greater than or equal to the layer thickness of the polar solvent 31a or the non-polar solvent 31b in which the flakes disperse, and if the height is set to be less than or equal to 5 μm, then the width of the ribs 24 can be set to be very narrow, and therefore the area in which flakes do not exist can be reduced.

The material of the ribs 24 is not limited in particular as long as the shape mentioned above can be formed. A photosensitive resin or the like used to form an ordinary resin spacer can be used, for example.

The ribs 24 may be formed on the substrate after hydrophobic treatment or hydrophilic treatment is applied, but in order to make the position of the two solvents in the vicinity of the ribs 24 constant, and from the perspective of making the process easier, it is preferable that hydrophobic treatment or hydrophilic treatment be applied after the ribs 24 are formed on the substrate.

In this manner, in the display panel 2, if the shape-anisotropic members 32 have hydrophilic characteristics, then the ribs are formed on the substrate that is hydrophilic of the substrates 10 and 20, and if the shape-anisotropic members 32 have hydrophobic characteristics, it is preferable that the ribs 24 be formed on the substrate that is hydrophobic of the substrates 10 and 20.

By forming this type of ribs 24, the polar solvent 31a (or non-polar solvent 31b) having flakes dispersed can be trapped in a small room or continuous small rooms surrounded by a substrate, the ribs 24 and the non-polar solvent 31b (or polar solvent 31a).

As a result, deviation in flake density due to coagulation or the like caused by gravity and applying voltage can be prevented.

### Embodiment 2

A display device related to Embodiment 2 of the present invention will be explained using drawings. In the descriptions below, the main differences between the semiconductor devices related to Embodiment 1 and Embodiment 2 will be described, and the respective constituting elements that have the same function will be given the same reference character and the description thereof will be omitted.

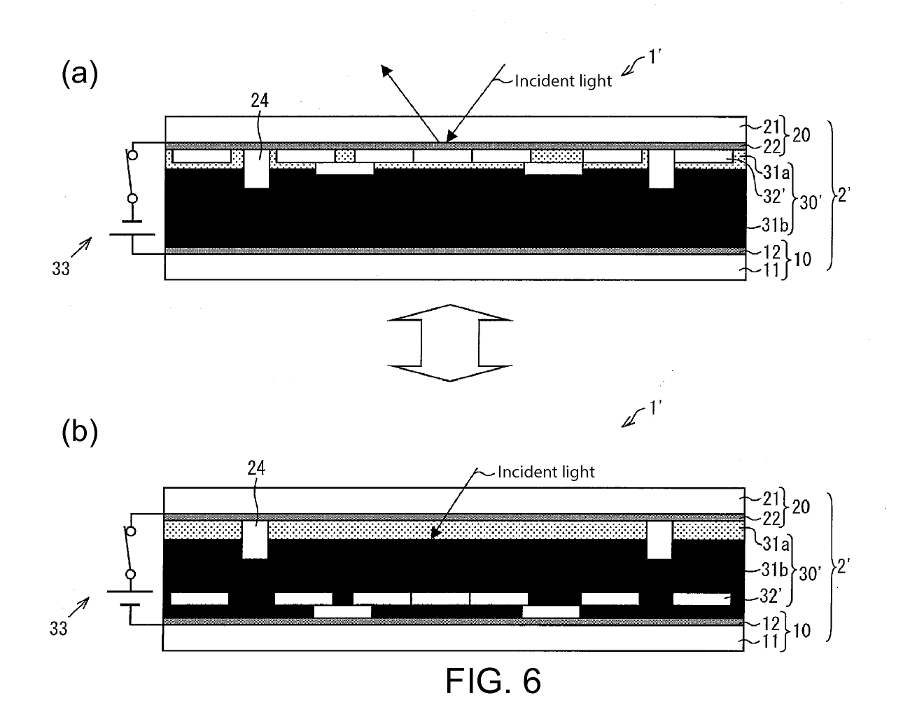

FIGS. 6(a) and 6(b) are cross-sectional views showing a schematic configuration of a display device 1′ according to Embodiment 2. The display device 1′ has a display panel 2′ and driving circuits (not shown), and is a reflective-type that performs display by reflecting external light that is incident on the display panel 2′.

The display panel 2′ includes a pair of substrates 10 and 20 arranged facing each other, and a light modulation layer 30′ disposed between this pair of substrates 10 and 20. The substrate 10 (first substrate) is disposed on the rear side of the display panel 2 and the substrate 20 (second substrate) is disposed on the display surface side (viewer's side). The display panel 2′ has a plurality of pixels arranged in a matrix.

(Light Modulation Layer)

The light modulation layer 30′ is provided between the electrodes 12 and 22, and the medium (polar solvent 31a and non-polar solvent 31b) includes a plurality of shape-anisotropic members 32′. When a voltage is applied by a power source 33 connected to the electrodes 12 and 22, the light modulation layer 30′ changes the reflectance of light (external light) that enters therein in accordance with the size of the applied voltage.

As shown in Embodiment 1, the medium includes the polar solvent 31a that is in contact with the hydrophilic substrate 20, and the non-polar substrate 31b that is in contact with the hydrophobic substrate 10.

(Shape-Anisotropic Members)

The shape-anisotropic members 32′ are members that received amphipathic treatment. Specifically, members covered by amphipathic polyelectrolytes that are synthesized by random copolymerization of hydrophobic monomers and electrolyte monomers having quaternary ammonium salts can be used, for example. The shape-anisotropic members 32′ are members having a positive or negative charge in the medium. The other characteristics of the shape-anisotropic members 32′ are the same as the shape-anisotropic members 32 shown in Embodiment 1.

This type of shape-anisotropic members 32′ is easily scattered with respect to the polar solvent and the non-polar solvent. As a result, when the voltage is applied to the light modulation layer 30′, compared to the shape-anisotropic members having hydrophilic treatment applied thereto, the shape-anisotropic members 32′ can move in the interface between the polar solvent 31a and the non-polar solvent 31b with a weak force, or in other words, with a low voltage. As a result, the display panel 2′ can be driven with a low voltage.

(Method of Controlling Reflectance of Light by Light Modulation Layer)

Next, a method of controlling the reflectance of light using the light modulation layer 30′ will be described in detail. Here, the anisometric members 32′ will be described as being flakes. The shape-anisotropic members 32′ are positively charged in the medium. In addition, the non-polar solvent 31b is colored in black.

As shown in FIG. 6(a), if a direct current voltage is applied to the light modulation layer 30′ from the power source 33, then the flakes are trapped in a certain narrow area within the polar solvent 31a in a scattered state. In other words, the flakes are stable in a position (inside the polar solvent 31a) within the polar solvent 31a, and are oriented (horizontally oriented) so as to attach to the hydrophilic substrate 20. As a result, the light (external light) that is incident on the light modulation layer 30 is reflected by the flakes, and reflective display (white display) is performed.

If a voltage having opposite polarity from that in FIG. 6 is applied to the light modulation layer 30′ from the power source 33, then, as shown in FIG. 6(b), the flakes enter the non-polar solvent 31b (also referred to as black medium) that is colored in black. As a result, the incident light that enters the light modulation layer 30′ is absorbed by a pigment in the non-polar solvent 31b. Thus, the viewer sees the black color of the non-polar solvent 31b (black display).

(Rib)

The ribs 24 are provided on the substrate (substrate 20 in FIG. 6) onto which the flakes attach in a similar manner to the display panel 2 of Embodiment 1. As a result, deviation in flake density due to coagulation or the like caused by gravity and applying voltage can be prevented.

The ribs 24 may be formed on one of the substrates 10 and 20 or on both substrates. The other characteristics of the ribs 24 are similar to Embodiment 1.

Also, depending on the material used for the interface treatment, it is possible to control the material to gather inside the polar solvent 31a by being left for a long time, for example. Therefore, when the voltage is not in a state of being attracted to the substrates 10 and 20, the flakes can be trapped in an area surrounded by the ribs 24. As a result, a display region without deviations can be obtained even when nothing is done.

### Embodiment 3

A semiconductor device related to Embodiment 3 of the present invention will be explained using drawings. In the descriptions below, the main differences from the semiconductor devices related to Embodiment 1 and Embodiment 2 will be described, and the respective constituting elements that have the same function will be given the same reference character and the description thereof will be omitted.

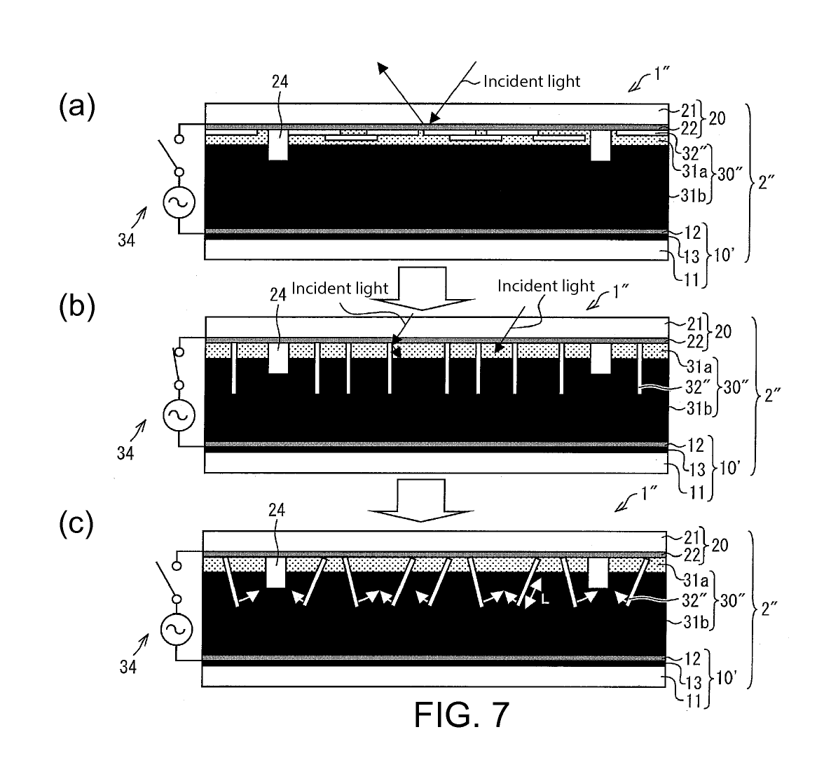

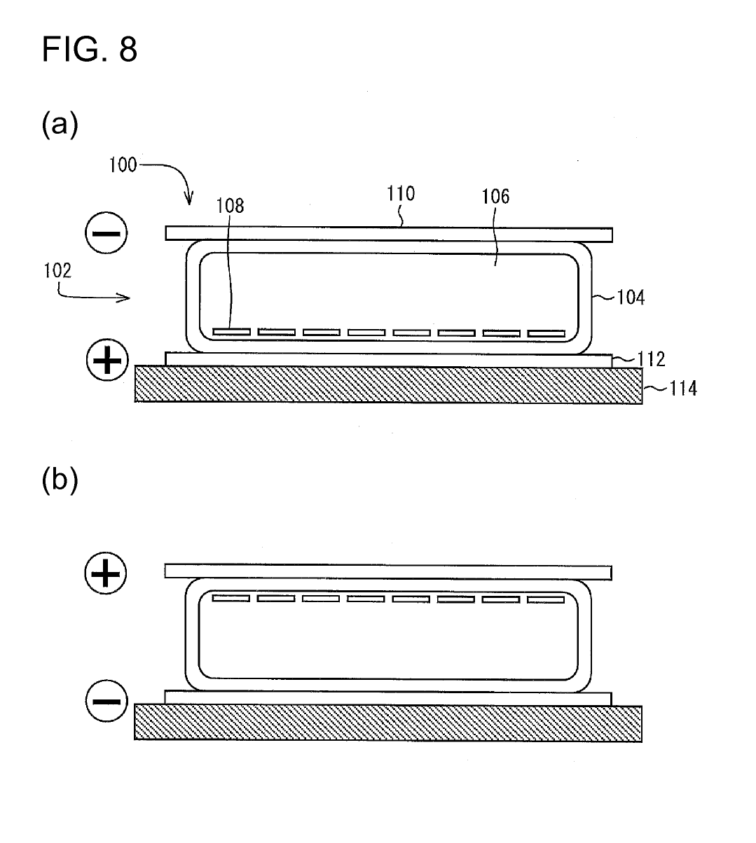

FIGS. 7(a) and 7(b) are cross-sectional views showing a schematic configuration of the display device 1″ related to Embodiment 3, and 7(c) shows how the flakes rotate by interfacial tension that occurs between the flakes and the non-polar solvents.

The display device 1″ has a display panel 2″ and driving circuits (not shown), and is a reflective-type that performs display by reflecting external light that is incident on the display panel 2″.

The display panel 2″ has a pair of the substrates 10′ and 20 disposed so as to face each other, and has a light modulation layer 30″ disposed between the pair of substrates 10′ and 20. The substrate 10′ (first substrate) is disposed on the rear side of the display panel 2 and the substrate 20 (second substrate) is disposed on the display surface side (viewer's side). The display panel 2″ has a plurality of pixels arranged in a matrix.

The substrates 10′ and 20 respectively has the insulating substrate 11 and 21 formed of transparent glass substrates, and electrodes 12 (first electrode) and 22 (second electrode). In a similar manner to the display device 1 (FIG. 1) of Embodiment 1, the substrate 10′ has hydrophobic characteristics and the substrate 20 has hydrophilic characteristics.

The substrate 10′ is an active matrix substrate. Specifically, the substrate 10′ has various signal lines (scan signal line, data signal line, and the like), thin-film transistors, and an insulating film, and a light-absorption layer 13 and an electrode 12 on top of these. The light-absorption layer 13 has characteristics that absorb light of at least a certain range of wavelengths of the light that enters therein. The light-absorption layer 13 may be colored, and is black, for example. In the present embodiment, as shown in FIG. 7, the substrate 10′ includes the light-absorption layer 13, but the present invention is not limited to this. The substrate 10′ may be a configuration that does not include the light-absorption layer 13 in a manner similar to that of Embodiment 1.

(Light Modulation Layer)

The light modulation layer 30″ is provided between the electrodes 12 and 22, and the light modulation layer 30″ is provided with the medium (polar solvent 31a and non-polar solvent 31b), and a plurality of shape-anisotropic members 32″ included in the medium. When a voltage is applied by a power source 34 connected to the electrodes 12 and 22, the light modulation layer 30″ changes the reflectance of light (external light) that enters therein in accordance with the size of the applied voltage.

The medium is formed of the polar solvent 31a that is in contact with the hydrophilic substrate 20 and the non-polar solvent 31b that is in contact with the hydrophobic substrate 10′.

(Shape-Anisotropic Member)

The shape-anisotropic members 32″ are response members that rotate or change shape in accordance with the direction of the electric field. In terms of display characteristics, the projection area (projection area to substrates 10′ and 20) changes depending on the size of the applied voltage seen from a direction normal to the substrates 10′ and 20. It is preferable that the projected area ratio (maximum projected area:smallest projected area) be at least 2:1. The shape-anisotropic members 31 and 31′ in Embodiments 1 and 2 had a charge, but the shape-anisotropic members 32″ of the present embodiments is not limited to this, and may or may not have a charge. The other characteristics of the shape-anisotropic members 32″ are the same as the shape-anisotropic members 32 shown in Embodiment 1.

(Light Reflectance Control Method Using Light Modulation Layer)

Next, a method of controlling the reflectance of light using the light modulation layer 30″ will be described in detail. Here, a case in which a hydrophilic aluminum (Al) flake is used as the shape-anisotropic member 32″ is explained. Furthermore, the non-polar solvent 31b is colored in black.

As shown in FIG. 7(a), when the alternating current voltage is not applied to the light modulation layer 30″, then the flakes are trapped in a certain narrow area in the polar solvent 31a in a scattered state. In other words, the flakes are stably positioned in the polar solvent 31a (inside polar solvent 31a) and are oriented (horizontally oriented) so as to attach to the hydrophilic substrate 20. As a result, the external light that entered the light modulation layer 30″ is reflected by the flakes and reflective display can be achieved.

If an alternating current voltage of 60 Hz is applied to the light modulation layer 30″, then, as shown in FIG. 7(b), dielectrophoresis, Coulomb's force, or electrical energy causes the flakes to enter an orientation such that the long axes thereof are parallel to the lines of electric force. In other words, the flakes are oriented (vertically oriented) in a direction such that the long axis of the flakes are perpendicular to the substrates 10′ and 20. As a result, the incident light that enters the light modulation layer 30″ is absorbed by the pigments of the non-polar solvent 3 lb. Furthermore, as shown in FIG. 7(b), because the reflective surfaces of the flakes are oriented perpendicular to the substrate, even if the flakes exist in a shallow position to the lower layer (non-polar solvent 31b), the incident light is reflected by the flakes and are absorbed by the pigment of the non-polar solvent 31b. As a result, the light that is incident on the light modulation layer 30″ do not exit towards the viewer and a black display having very low reflectance can be performed. Therefore, excellent display with high contrast can be obtained.

In FIG. 7(b), if the voltage is not applied to the light modulation layer 30″, then due to the interfacial tension that occurs between the flakes and the non-polar solvent 31b, as shown in FIG. 7(c), the flakes rotate and become oriented (horizontally oriented) such that the long axes thereof become parallel to the substrates 10′ and 20. As a result, the external light that is incident on the light modulation layer 30″ is reflected by the flakes and reflective display can be achieved.

In the present embodiment, descriptions were provided using the shape-anisotropic members 32″ having hydrophilic characteristics as an example, but the shape-anisotropic members 32″ are not limited to this, and may have hydrophobic characteristics, or may have amphipathic characteristics. When the shape-anisotropic members 32″ have amphipathic characteristics, then it is preferable that the shape-anisotropic members 32″ have a negative charge, and that when the shape anisotropic members 32″ are in a reflective state, a positive charge be applied to the electrode 22 (second electrode) to obtain a horizontal orientation.

The present invention is not limited to the respective embodiments mentioned above, and various modifications can be applied within the scope of the claims. Therefore, embodiments that appropriately combine the techniques described in different embodiments are included in the technical scope of the present invention.

### INDUSTRIAL APPLICABILITY

The present invention is suitable for displays such as television.

### DESCRIPTION OF REFERENCE CHARACTERS

1, 1′, 1″ display device

2, 2′, 2″ display panel

10, 10′ substrate (first substrate)

11 insulating substrate

12 electrode (first electrode)

13 light-absorption layer

20 substrate (second substrate)

21 insulating substrate

22 electrode (first electrode)

24 rib

30, 30′, 30″ light modulation layer

31a polar solvent

31b non-polar solvent

32, 32′, 32″ shape-anisotropic member

33 power source

34 power source

1. A display panel, comprising:
a first substrate on a rear surface side;
a second substrate on a display surface side facing the first substrate; and
a light modulation layer that is disposed between the first substrate and the second substrate and that controls a degree of reflection of light incident thereon,
wherein the light modulation layer includes a polar solvent, a non-polar solvent, and a plurality of shape-anisotropic members having one of hydrophilic, hydrophobic, and amphipathic characteristics,
wherein one of the first substrate and the second substrate has the hydrophilic characteristics and is in contact with the polar solvent,
wherein another one of the first substrate and the second substrate has the hydrophobic characteristics and is in contact with the non-polar solvent,
wherein one of the polar solvent and the non-polar solvent that is in contact with the first substrate has light absorbing characteristics, and
wherein a position of the shape-anisotropic members in the light modulation layer is changed by changing a voltage applied to the light modulation layer.

2. The display panel according to claim 1, wherein said one of the polar solvent and the non-polar solvent that is in contact with the first substrate includes a black pigment.

3. The display panel according to claim 1,
wherein, when the shape-anisotropic members have hydrophilic characteristics, the shape-anisotropic members are confined within the polar solvent when a voltage is not applied to the light modulation layer,
wherein, when the shape-anisotropic members have the hydrophobic characteristics, the shape-anisotropic members are confined within the non-polar solvent when a voltage is not applied to the light modulation layer, and
wherein, when the shape-anisotropic members have the amphipathic characteristics, the shape-anisotropic members are confined within one of the polar solvent and the non-polar solvent when a voltage is not applied to the light modulation layer.

4. The display panel according to claim 1,
wherein, when the shape-anisotropic members have the hydrophilic characteristics, a layer thickness of the polar solvent is less than a layer thickness of the non-polar solvent, and
wherein, when the shape-anisotropic members have the hydrophobic characteristics, the layer thickness of the non-polar solvent is less than the layer thickness of the polar solvent.

5. The display panel according to claim 1, wherein the light modulation layer absorbs light when a voltage is applied to the light modulation layer, and reflects light when a voltage applied to the light modulation layer is 0.

6. The display panel according to claim 1, wherein changing the voltage applied to the light modulation layer changes an area of the shape-anisotropic members projected onto the first substrate and the second substrate.

7. The display panel according to claim 1, wherein the shape-anisotropic members have a charge.

8. The display panel according to claim 1,
wherein the shape-anisotropic members have one of the hydrophilic characteristics and the hydrophobic characteristics,
wherein, when the shape-anisotropic members have the hydrophilic characteristics, ribs are formed on one of the first substrate and the second substrate having the hydrophilic characteristics, and
wherein, when the shape-anisotropic members have the hydrophobic characteristics, the ribs are formed on one of the first substrate and the second substrate having the hydrophobic characteristics.

9. The display panel according to claim 1,
wherein the shape-anisotropic members have the amphipathic characteristics, and
wherein a rib is formed on at least one of the first substrate and the second substrate.

10. The display panel according to claim 8, wherein the rib is formed in a grid shape or an island shape.

11. The display panel according to claim 8, wherein a height of the rib is substantially the same as a thickness of the light modulation layer.

12. The display panel according to claim 1, wherein a height of the rib is 5 μm or less.

13. The display panel according to claim 1, wherein the shape-anisotropic members are formed of a metal, a semiconductor, a dielectric material, a dielectric multilayer film, or a cholesteric resin.

14. The display panel according to claim 1, wherein the shape-anisotropic members are formed of a metal and reflect light radiated thereto.

15. The display panel according to claim 1, wherein the shape-anisotropic members are colored.

16. The display panel according to claim 1, wherein the shape-anisotropic members are formed in a flake shape, a columnar shape, or an elliptical sphere shape.

17. The display panel according to claim 1, wherein the shape-anisotropic members are formed in a flake shape and have recesses and protrusions.

18. A display device, comprising the display panel according to claim 1.
